(19) United States
(12) Patent Application Publication
(10) Pub. No.: US 2004/0097323 A1
(43) Pub. Date: May 20, 2004

(54) Torque biasing assembly and method

(76) Inventor: Xiaohong N. Duan, Canton, MI (US)

Correspondence Address: Dickinson Wright PLLC, Suite 800, 1901 L. Street NW, Washington, DC, 20036, US

(21) Appl. No.: 10/295,989

(22) Filed: Nov. 15, 2002

(51) Int. Cl. F16D 13/04; F16D 23/00; F16D 41/00; F16D 43/00; F16H 3/74

(52) U.S. Cl. 475/254

(57) ABSTRACT

A torque biasing assembly, such as for use in a vehicle, to selectively resist relative rotation between a casing and first driven shaft. The torque biasing assembly includes the casing, the first driven shaft, first and second torque biasing mechanisms, and a pressure control system communicating with the biasing mechanisms. The first and second biasing mechanisms are each operatively connected to the casing and the first driven shafts and are operable in an engaged condition to impede rotation of the first driven shaft relative to the casing as well as a disengaged position. The pressure control system is configured to selectively communicate pressurized fluid to the torque biasing mechanisms to position the torque biasing assembly in a no-biasing state, first biasing state, and a second biasing state.

### BACKGROUND OF THE INVENTION

The present invention is generally directed to a torque biasing assembly for selectively coupling drive shafts in a vehicle drive train and, more particularly, to a torque biasing assembly that provides two step torque biasing as well as a hybrid clutch assembly for torque biasing.

Torque biasing assemblies are currently used in the automotive arts to transfer torque between two members. For example, conventional two-wheel-drive vehicles include a front or rear driven axle and a rear or front non-driven axle. Sometimes, a limited slip differential is included in the driven axle to selectively bias drive line torque between right and left axle half-shafts. Similarly, in four-wheel-drive vehicles, torque biasing assemblies are used to bias or transfer torque between selectively driven front and rear axles. As the size and power of motor vehicles have increased over the years, torque biasing assemblies have evolved to become more robust. However, with the ever increasing desire for more fuel efficient vehicles, weight and space constraints for vehicle components, including torque biasing assemblies, have increased. These limitations may prevent conventional devices from providing the desired or required torque capacity for the vehicle.

### SUMMARY OF THE INVENTION

In view of the above, the present invention is generally directed to a torque biasing assembly, such as for use in a vehicle, to selectively resist relative rotation between a casing and first driven shaft. The torque biasing assembly includes the first driven shaft, first and second torque biasing mechanisms, and a pressure control system communicating with the biasing mechanisms. The first and second biasing mechanisms are each operatively connected to the casing and the first driven shafts and are operable in an engaged condition to impede rotation of the first driven shaft relative to the casing as well as a disengaged position. The pressure control system is configured to selectively communicate pressurized fluid to the torque biasing mechanisms to position the torque biasing assembly in a no-biasing state, first biasing state, and a second biasing state.

By this configuration, the torque biasing assembly of the present invention has high torque to weight density that, when compared to prior art systems, exerts greater torque and has greater capacity for a given weight and size. These greater capacities are particularly advantageous in high torque biasing applications such as those required for larger trucks and sport utility vehicles.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a schematic illustration of an on-demand four wheel drive vehicle having a torque biasing assembly according to the present invention;

FIG. 2 is a schematic illustration of the torque biasing assembly of the present invention used in a limited slip differential on the rear axle of a motor vehicle;

FIG. 3 illustrates the torque biasing assembly of the present invention for use with the differential shown in FIG. 2;

FIG. 4 is an enlarged schematic illustration of the pressure control system and first torque biasing mechanism illustrated in FIG. 3;

FIG. 5 is a sectional view of a hybrid clutch as the second torque biasing mechanism in the present invention with the coupler in its disengaged position;

FIG. 6 is a cross-sectional view similar to FIG. 5 showing the coupler in the engaged position;

FIG. 7 is a cross-sectional view of the coupler and differential case taken along the line 7-7 shown in FIG. 6;

FIG. 8 is a sectional view taken along the line 8-8 shown in FIG. 6 and illustrating a fluid passage in the coupler;

FIG. 9 is a sectional view of the coupler and differential case taken along the line 9-9 shown in FIG. 5;

FIG. 10 is a cross-sectional view of the coupler and differential case taken along the line 10-10 shown in FIG.5;

FIG. 11 is a detail showing a representative piston tooth and carrier shoulder interengagement;

FIG. 12 is a cross-sectional view similar to that shown in FIG. 7 with the coupler teeth disposed within the annular cavities in the differential case;

FIG. 13 illustrates an alternative embodiment of the torque biasing assembly of the present invention; and

FIG. 14 illustrates the alternative embodiment shown in FIG. 13 with the position valve in its second position.

### DETAILED DESCRIPTION OF THE PREFERRED EMBODIMENT

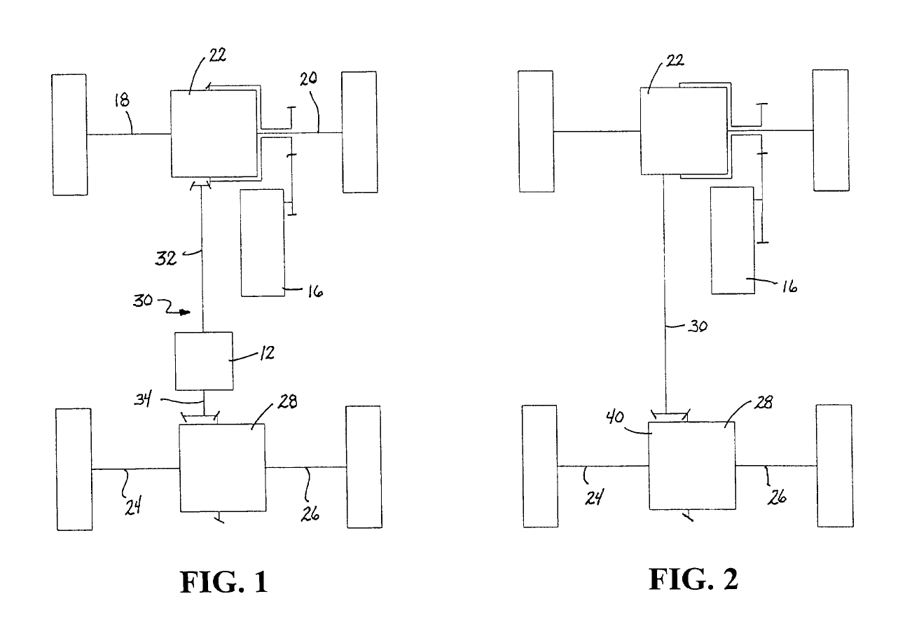

The present invention is generally directed to a torque biasing assembly 10 for transferring torque between two rotatable shafts. The invention is suitable for a variety of vehicle applications including, but not limited to, the exemplary applications illustrated in FIGS. 1 and 2.

In FIG. 1, the torque biasing assembly is included with a drive shaft coupler 12 of an on-demand four wheel drive vehicle 14. As shown, the vehicle is powered by an engine/transmission 16 and includes front axle half-shafts 18 and 20, a front differential 22, rear axle half-shafts 24 and 26, a rear differential 28, and an inter-axle drive shaft 30. In this embodiment, the drive shaft coupler 12 is interposed between the front and rear differentials to control the rotation of the front and rear drive shaft segments 32 and 34. As will be more fully appreciated from the following description, during normal driving conditions in an on-demand four-wheel drive vehicle, the drive shaft coupler 12 of FIG. 1 is not engaged and the vehicle 14 operates in two wheel drive mode. When four wheel drive is desired, the coupler 12 is engaged to place the vehicle in four wheel drive mode and transfer torque to the rear wheel drive shaft segment 34.

In FIG. 2, the torque transfer assembly is included with a limited slip differential 40 for the rear axle half-shafts 24 and 26 of the vehicle 14. As will be more fully appreciated from the following description, during normal driving conditions, the limited slip differential 40 of FIG. 2 is not engaged and the half-shafts 24 and 26 are permitted to rotate at different speeds, such as to facilitate for vehicle turning. In certain conditions, for example during wheel slip where one of the half-shafts rotates much faster than the other, the differential 40 may be engaged thereby transferring additional torque to the non-slipping wheel and forcing the half-shafts to rotate at or closer to the same speed.

With these exemplary illustrations, those skilled in the art will appreciate that the torque transfer assembly of the present invention is suitable for a variety of other applications. For example, the system may be used in a front, rear, or central differential as a limited slip differential, as a twin coupler in auxiliary drive axles, and as a coupler to couple the front and rear shaft segments in an on-demand four-wheel-drive vehicle.

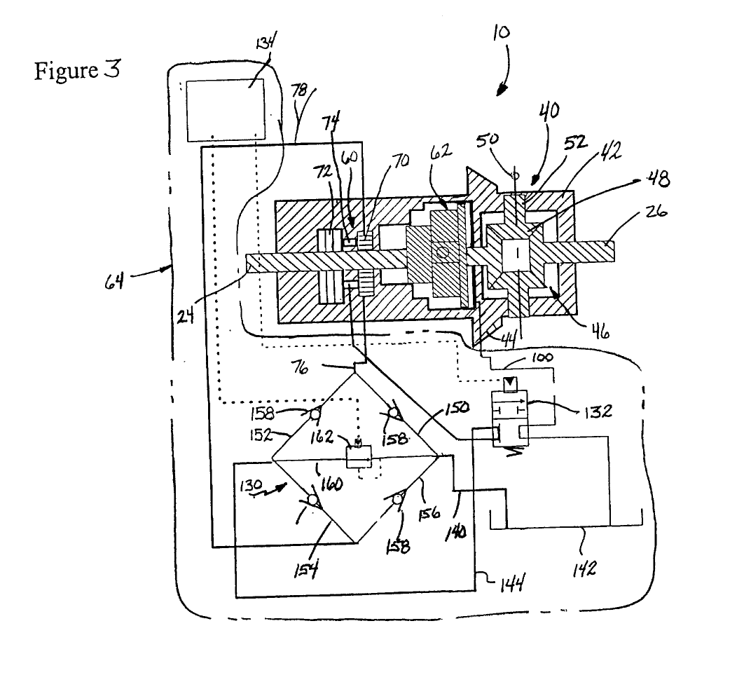

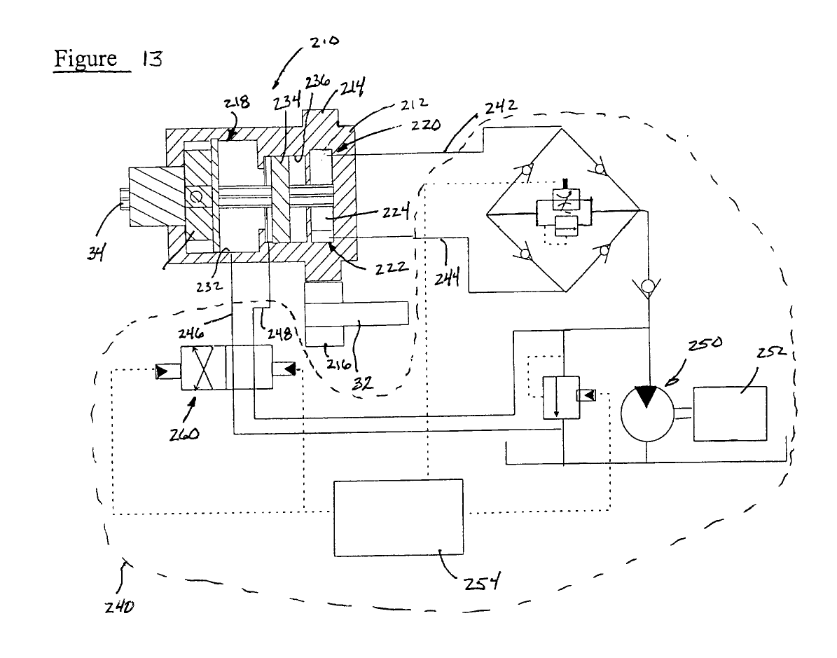

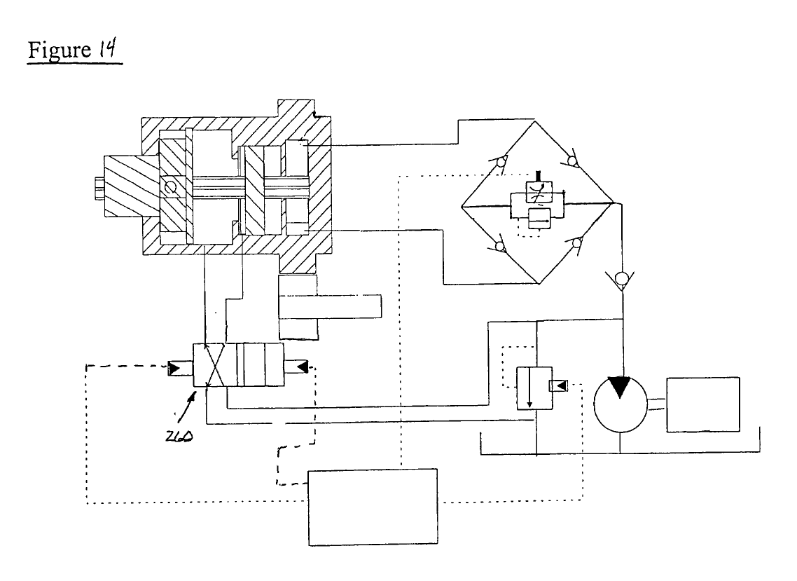

FIG. 3 illustrates the limited slip differential 40 of FIG. 2 in greater detail and to include a differential case, casing, or carrier 42 with a ring gear 44 that may be meshed with a geared section, such as a hypoid bevel gear, of the drive shaft 30 (FIG. 2). First and second rear axle half-shafts 24 and 26 are partially disposed in the case 42 and are rotatable relative thereto. The differential 40 further includes a differential gear set 46, such as the illustrated pinion gears 48 that rotate with the case 42 and are rotatable about an axis 50 of pinion shafts 52 to permit the half-shafts 24 and 26 to rotate relative to one another. It should be appreciated that while the case 42 illustrated in FIGS. 3-12 and the case of the alternative embodiment illustrated in FIGS. 13 and 14 are shown and described in detail herein as being rotatably driven by a drive shaft 30 (FIG. 3) or input shaft 32 (FIG. 13), a variety of modifications to the general configurations described herein may be made without departing from the scope of the invention. For example, while the case is illustrated and described herein as having ring gear 44 for driving engagement with a geared shaft, the two step biasing assembly and method described herein are equally suited for use in applications where the case 42 is fixed to rotate with one of the half-shafts 24 or 26 or similar alternative configurations.

The torque biasing assembly embodied in the differential 40 includes first and second torque biasing mechanisms providing two step torque biasing as hereinafter described. A pressure control system 64 hydraulically communicates with the first and second torque biasing mechanisms to selectively operate the torque biasing assembly in a no biasing state when the first and second torque biasing mechanisms are in their disengaged conditions; a first biasing state when the first biasing mechanism is in an engaged condition and the second torque biasing mechanism is in a disengaged condition; and a second biasing state when the first and second torque biasing mechanisms are each in their engaged conditions. By this configuration, the individual components of the torque biasing assembly of the present invention are able to be reduced in size thereby more effectively accommodating industry space requirements. Moreover, the robustness of the individual components may be reduced and the present invention provides a higher torque to weight density when compared to prior art systems, that is, the invention is capable of exerting greater torque and has greater capacity for a given weight and size. These greater capacities are particularly advantageous in high torque biasing applications commonly required for larger trucks and sport utility vehicles. In comparison to some conventional devices, the present invention is capable of transferring eighty percent greater torque with a device that is approximately 2/3 the weight.

In the embodiment illustrated in FIGS. 3-10 the first torque biasing mechanism is a hydraulically actuated friction clutch 60 and the second torque biasing mechanism is a hybrid clutch 62, each of which hydraulically communicate with the pressure control system 64. The hydraulically actuated friction clutch 60 is shown to include a pump 70, clutch pack 72, and a clutch actuator 74. While a representative configuration and operation for each of these components is described and illustrated herein, those skilled in the art will appreciate that each may be of virtually any suitable conventional construction. By way of example rather than limitation, the pump 70 is described herein as a gerotor pump, the clutch pack 72 as an interleaved wet clutch pack, and the clutch actuator 74 as a hydraulically controlled piston actuator. By way of further illustration, the pump may include gear, vane and piston type hydraulic pumps, the clutch pack may include wet and dry clutches, and the clutch actuator may include a cylindrical linear piston cylinder, several circularly arranged piston cylinders, or a rotational cylinder with rotational or linear motion translation mechanisms. The pump of the illustrated embodiment and the pressure control system allows the pump to rotate in clockwise and counterclockwise directions so as to selectively drive the vehicle shafts in forward and rearward directions. Instead of driving by relative rotation of case and the first shaft, the pump can also be driven by a electric motor, and located outside of case.

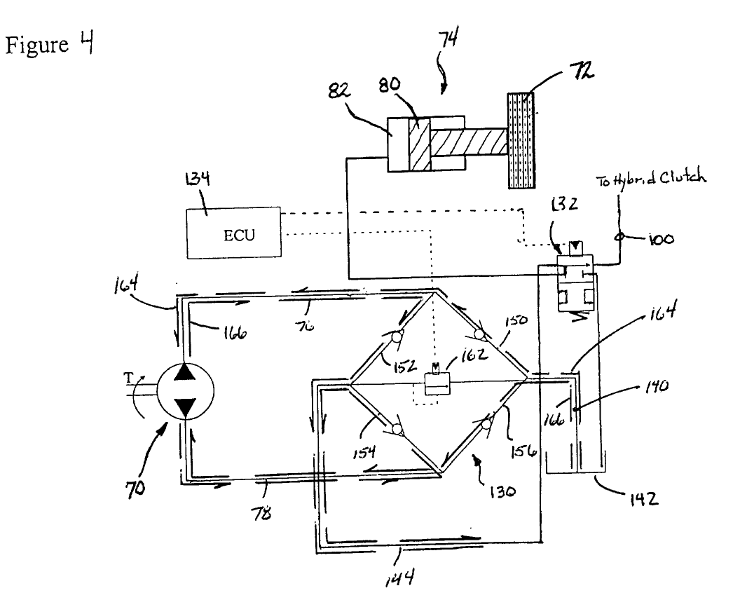

Turning now to a detailed description of the illustrated hydraulically actuated friction clutch 60 (FIGS. 3 and 4), the illustrated gerotor pump 70 includes a chamber with two ports communicating with first and second fluid conduits 76 and 78, a first pump element, such as an outer rotor, disposed within the differential case 42, and free to rotate relative to case 42. A second pump element (such as an inner rotor) is also disposed within the chamber and rotates with the first half-shaft 24. In the described embodiment, the outer rotor is eccentrically located within the case 42 and the inner rotor and case 42 have a common rotational axis. Thus, when the first half-shaft 24 rotates at the same speed as the case 42, the pump does not displace any fluid. Conversely, when the first half-shaft 24 rotates slower or faster than (e.g., clockwise or counterclockwise relative to) the case 42, the pump displaces fluid in first or second directions through the conduits 76 and 78.

As noted above, the pressure control system 64 controls the fluid pressure within the system to selectively position the first torque biasing mechanism (e.g., the hydraulically actuated from clutch 60) and the second torque biasing mechanism (e.g., the hybrid clutch 62) in their respective engaged and disengaged conditions. In general, when no torque biasing is desired from the clutch 60, the pressure control system permits the pump 70 to freely draw and discharge fluid into and through the pump chamber as well as from and to the fluid reservoir. Conversely, when torque biasing is desired from the hydraulic clutch, the flow from the pump through the fluid conduits 76 and 78 is restricted or prevented so that pressure builds within the pump chamber. The pressure control system 64 then controls the pressure and fluid flow to selectively actuate the first and second torque biasing mechanisms as described below.

To place the first torque biasing mechanism in its engaged condition, the pressure control system 64 selectively communicates pressurized fluid generated by the pump 70 to the actuator 74 whereupon the actuator 74 engages the clutch pack 72 to restrict relative rotational movement between the axle half-shaft 24 and the case 42. More specifically, pressurized fluid communicated to the clutch actuator 74 creates an increase in fluid pressure within the piston chamber 82 tending to displace the piston 80 to engage the clutch pack 72. It should also be noted that the operation of the pump to displace fluid also acts to transfer torque between the differential case 42 and half-shaft 24.

Those skilled in the art will appreciate that while a representative first torque biasing mechanism in the form of friction clutch 60 is described in detail above, a variety of other suitable torque biasing mechanisms are known in the art and may be used with the present invention without departing from the scope of the appended claims. By way of example rather than limitation, other hydraulically controllable biasing mechanisms such as, as noted above, different pump configurations as well as alternative clutch packs and actuators may be used. 100321 The second torque biasing mechanism is illustrated in FIGS. 3 and 5-10 as a hybrid clutch 62. The hybrid clutch provides a hydraulically actuated mechanical rotational interlock between the first half-shaft 24 and the differential case 42. More particularly, in its disengaged condition (FIG. 5), the hybrid clutch 62 does not restrict or impede rotation of the first half-shaft 24 relative to the case 42. However, in its fully engaged condition (FIG. 6), the hybrid clutch rotational couples the first half-shaft 24 to the case 42 by mechanical engagement.

As is best illustrated in FIGS. 5-10, the hydraulically actuated hybrid clutch 62 is shown to include a sliding coupler 86 disposed within a cavity of the differential case 42. The sliding coupler 86 moves within a clutch chamber 88 defined by the differential case 42 and is splined or otherwise coupled to rotate with and be axially movable along the first half-shaft 24. The coupler 86 includes a body 90, radially extending teeth 92, and a flange 94. The coupler 86 separates the clutch chamber 88 into a first sub-chamber 96 and a second sub-chamber 98 (FIG. 6). A second torque fluid conduit 100 communicates with the first sub-chamber 96 to communicate fluid to and from the chamber 88 under the control of the pressure control system 64 as hereinafter described.

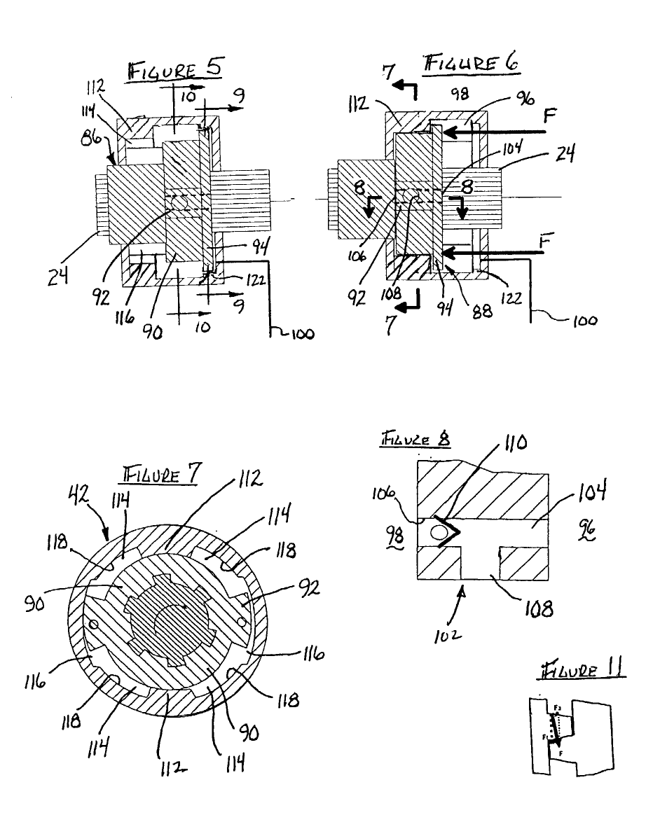

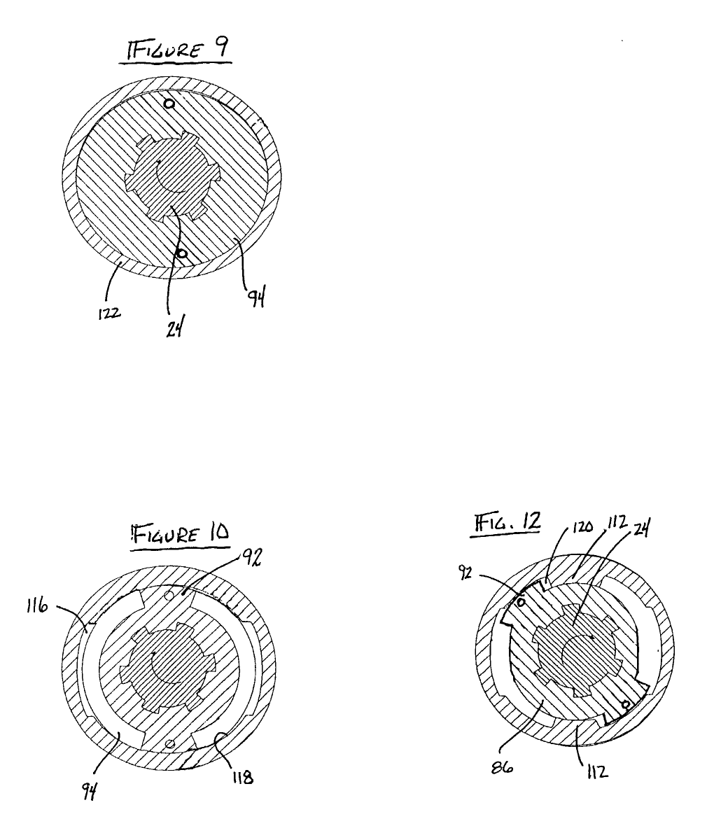

The case 42 has a generally tubular configuration and, as noted above, defines a clutch chamber 88. As is best illustrated in FIGS. 5-7, one or more case teeth 112 extend a predetermined axial and radial distance into the chamber 88. The cross-sectional configuration of this first portion of the chamber (FIG. 7) preferably includes a pair of opposed teeth 112, radially extending annular cavities 114 on each side thereof, and opposed radial recesses 116 separating adjacent cavities 114. The recesses 116 extend longitudinally into a second, central portion of the chamber 88 (FIG. 10). Finally, a third chamber portion (FIG. 9) includes a case shoulder 122 that extends a predetermined axial and radial distance into the chamber 88.

The configuration of the chamber 88 cooperates with a fluid passage 102 in the coupler 86 that selectively hydraulically interconnects the first and second sub-chambers 96 and 98 to control the axial and rotational movement of the coupler. While a variety of passage configurations may be used with the present invention, the illustrate passage 102 has a “T” configuration with a first axial leg 104 communicating with the first pressure sub-chamber 96, a second axial leg 106 communicating with the second pressure sub-chamber 98, and a radial leg 108 also opening to the second pressure sub-chamber 98 (FIG. 8). A check valve 110 permits fluid flow in only one direction through second axial leg 106. By this arrangement, fluid flow is permitted from the first pressure sub-chamber 96 to the second pressure sub-chamber 98 at all times through the first and second axial legs 104 and 106. As is discussed in detail below, fluid flow is also permitted in certain instances between the first and second pressure sub-chambers through the first axial leg 104 and the radial leg 108.

With the above description of the structure of the hybrid clutch 62 in mind, a description of its operation will now be provided. The hybrid clutch is maintained in its disengaged condition, such as through the use of a spring or other biasing mechanism (not shown) when the torque biasing assembly is in the no-bias and first bias states. In this condition, the slidable coupler 86 is axially positioned on the shaft 24 as shown in FIG. 5 and the coupler flange 94 is disposed within the circumferential shoulder 122. The shoulders 122 are sized to prevent fluid flow between chambers 96 and 98 through the radial gap in recesses 116 when the coupler 86 is in the position shown in FIG. 5. As a result, fluid flow from the second chamber 98 to the first chamber 96 is prevented by the check valve 110 and the sealing of the radial leg 108. The coupler remains in this position so long as the fluid pressure force in the first sub-chamber 96 (i.e., the product of the fluid pressure and the longitudinal surface area upon which the force acts) is less than the sum of the fluid pressure force in the second sub-chamber 98 and the biasing force.

When it is desired to move the hybrid clutch 62 into its engaged condition, the pressure control system 64 provides fluid to the first sub-chamber 96 through fluid conduit 100. When the fluid pressure force in the first sub-chamber exceeds the sum of the fluid pressure force in the second sub-chamber 98 and the biasing force, the resultant force urges the coupler 86 along the shaft 24. The moving coupler compresses fluid in the second sub-chamber 98 thereby increasing the pressure therein. When the coupler 86 is axially displaced into the second portion of the chamber 88, fluid flow is permitted between the first and second sub-chambers through the axial leg 104 and radial leg 108 of fluid passage 102 if the coupler teeth 112 are rotationally positioned such that the radial leg 108 outlets to the recesses 116 as shown in FIG. 7. If the radial leg 108 outlets to the seal surface 118 the seal surface prevents fluid flow from leg 108. As the recesses 116 are aligned with one another in the first and second portions (e.g., FIGS. 7, 10, and 12, respectively) axial movement of the coupler 86 is resisted by the compressed fluid in the second sub-chamber 98 when any portion of the coupler teeth 92 align with the case teeth 112 thereby preventing undesirable impact forces between the teeth.

As the coupler 86 moves axially into the first portion of the chamber 88, fluid flow from the second sub-chamber 98 to the first sub-chamber 96 is again governed by the rotational position of the coupler, more particularly the radial leg 108, relative to the annular cavities 114 and recesses 116. If the radial legs 108 of passage 102 are positioned within the recesses 116 (FIG. 7), fluid is free to flow through radial legs 108. However, as the coupler rotates further, such that the legs 108 are positioned within case cavities 114, the sealing surface 118 blocks fluid flow through leg 108.

Further coupler rotation compresses the isolated fluid in the sub chamber 98 creating a counter force that dampens rotation of the coupler 86 into the engaged position. More particularly, as is generally illustrated in FIG. 12, further rotation of the coupler 86 relative to the case 42 traps a pocket 120 of fluid in the cavities 114 and the resulting pressure build-up in the cavities reduces the rotational speed of the coupler 86. The pressurized fluid trapped in the cavity 114 leaks from the sub-chamber 98 to the sub-chamber 96 around the coupler flange 94 thereby permitting controlled contact between the coupler teeth 92 and case teeth 112. When the coupler teeth 92 contact the case teeth 112, the coupler rotates at the same speed as the case 42.

Once the shaft 24 and case 42 are rotating at the same speed, the pump 70 no longer discharges pressurized fluid. With the decreased system pressure, the ECU moves the valve 132 to the position shown in FIG. 3, thereby removing the acting force and allowing the coupler 86 to axially move toward its disengaged position (FIG. 5) under the return force of the spring or other biasing mechanism. The return force may be provided by a variety of mechanisms. In the embodiment illustrated in FIG. 11, the piston teeth 92 and case shoulders 112 have a wedged configuration that facilitates axial movement of the coupler 86 to its disengaged position.

In view of the above, it will be appreciated that the coupler 86 and chamber 88 in the hybrid clutch 62 generally provide a movable coupler, valve, clutch, and damper. The coupler position controls the passage openings (most notably radial leg 108) which in turn control the fluid flow and the position or motion of the coupler. The motion and position of the coupler further control the engagement of the coupler, and the coupler position and passage opening stage form a hydraulic damper to facilitate the smooth engagement of the coupler and carrier teeth to place the second torque biasing mechanism in its engaged condition.

The above description of the present invention includes a general description of the generation of the pressurized fluid and the selected communication of this pressurized fluid to actuate the first and second torque biasing mechanisms. While a variety of pressure control systems may be used with the present invention, a suitable pressure control system 64 is illustrated and described herein. The pressure control system 64 (FIGS. 3 and 4) controls the hydraulic pressure within the system and includes a pressure control valve assembly 130 hydraulically communicating with the pump chamber via first and second pump conduits 76 and 78, a position valve 132, and an electronic control unit 134 controllably communicating with the pressure control valve assembly 130 and position valve 132. During normal driving conditions (i.e., where no torque biasing is required), the pressure control system 64 sets the system pressure as air pressure and both the hydraulically actuated friction clutch 60 and the hybrid clutch 62 are disengaged. So long as the rotational speed of the first and second output half-shafts 24 and 26 are equal, the hydraulic pump delivers no flow and the resistant torque provided by the pump 70 and clutch pack 72 are at or near zero. When the output half-shaft rotational speeds are different, the relative rotation of the pump components cause fluid flow. If no torque biasing is required, the pressure control system 64 maintains the system pressure at near air pressure and no resistant torque is provided to impede the relative rotation of the two shafts.

The illustrated position control valve assembly 130 is shown to communicate with the pump conduits 76 and 78 as well as a reservoir conduit 140 communicating with a fluid reservoir 142 and an actuator conduit 144 communicating with position valve 132 for selectively supplying pressurized fluid to the first and second torque biasing mechanisms as hereinafter described. The control valve assembly includes first, second, third, and fourth conduit segments 150, 152, 154, and 156, respectively, each having a check valve 158 to permit fluid flow within each segment along a single direction. The control valve assembly 130 also includes a bypass conduit 160 with a proportional pressure control valve 162 controlled by the ECU 134. The pressure control valve regulates the system pressure between air pressure, in an fully open position, and a system maximum setting pressure. The valve 162 is placed in its fully open position when the control valve assembly is in a non-biasing mode. By this configuration, the control valve assembly 130 defines a first fluid path 164 and a second fluid path 166 in the biasing mode operation (FIG. 4). The first fluid path 164 passes fluid through the reservoir conduit 140, the first conduit segment 150, the first pump conduit 76, the pump 70, the second pump conduit 78, the third pump segment 154, and to the actuator conduit 144. Fluid flowing through the second fluid path 166 passes through the reservoir conduit 140, the fourth conduit segment 156, the second pump conduit 78, the pump 70, the first pump conduit 76, the second conduit segment 152, and to the actuator conduit 144. Thus, with the valve 162 continually regulating the pump output pressure level, clockwise or counterclockwise rotation of the pump elements draws fluid from the reservoir and provides pressurized fluid to the position valve 132 whereupon the second biasing mechanism may be placed in its engaged condition by the ECU 134 through selective positioning of the valve 132. As noted above, when no torque biasing is required, the valve 162 is maintained in its fully open position (FIG. 3) whereupon relative rotation of the pump components circulates fluid through the control valve assembly 130 via the bypass conduit 160.

The ECU 134 is configured to selectively place the position valve 132 in a first position (FIG. 3) wherein pressurized fluid is provided only to the first torque biasing mechanism and a second position (FIG. 4) wherein pressurized fluid may be communicated to both the first and second torque biasing mechanism. More particularly, as is illustrated in FIG. 3, when the position valve 132 is in its first position, the actuator conduit 144 communicates fluid to the clutch actuator 74 (more particularly the piston chamber 82) and the conduit 100 is hydraulically connected to the reservoir 142 so as to drain pressurized fluid from the coupler chamber 88. In its second position, the position valve 132 isolates the coupler chamber 88 from the reservoir and provides fluid communication from the actuator conduit 144 to the conduit 100.

The ECU 134 is configured to move the position valve 132 from its first position (FIG. 3) to its second position when the second stage torque biasing is desired. It is noted that while a variety of valves and signaling/control techniques may be used with the present invention, the position valve 132 and similar valves described herein may be a solenoid controlled valve responsive to a control signal generated by the ECU. Alternatively, the valve may be a hydraulic actuated piston valve with control pressure being provided from a hydraulic conduit such as conduit 144. In any event, the movement of the position valve to its second position occurs in response to fluid pressure exceeding a predetermined value as measured by the ECU or communicated directly to the valve. Thus, the torque biasing assembly 10 of the present invention is a two-stage torque biasing mechanism in the sense that the first torque biasing mechanism is engaged when the relative rotation of the half-shaft 24 and carrier 42 generated fluid pressure below the predetermined value. When relative rotation increases, such that the fluid pressure exceeds the predetermined value, additional torque biasing is achieved through communication of pressurized fluid to the second torque biasing mechanism whereby, in the illustrated embodiment, the hybrid clutch 62 is moved to its engaged condition as described above.

Those skilled in the art will appreciate that a variety of modifications may be made to the invention as described above with reference to the embodiment illustrated in FIGS. 3-11. For example, while a particular pressure control system 64 and pressure control valve assembly 130 have been described herein, suitable alternatives generally known in the art may be used. Moreover, by way of example rather than illustration, while the passage 102 is shown in FIGS. 5-8 as being positioned within the coupler 86, those skilled in the art will appreciate that similar passages and functional operations may be achieved by placing one or more passages in the differential case 42.

Yet a further illustration of the modifications that may be made to the invention without departing from the scope thereof as defined by the appended claims, is provided by the alternative embodiment of the invention illustrated in FIGS. 13-14. In this embodiment, the torque biasing assembly 210 is included in a transfer case 12 such as that illustrated in FIG. 1. The transfer case 12 transfers torque from an input shaft 32 to an output shaft 34 and includes a housing 212 with a gear 214 meshed with the gear 216 of the input shaft 32. The output shaft 34 is rotatable within and relative to the housing 212.

Just as in the embodiment described above with reference to FIGS. 3-12, a first torque biasing mechanism includes a first hydraulic pump 220 contained within a pump chamber 222 defined by the housing 212. The pump 220 includes a first pump element rotating with the housing 212 and a second pump element, such as a gerotor rotor 224, rotating with the output shaft 34. The second torque biasing mechanism again includes a coupler 230 disposed within a clutch chamber 232 in the housing 212 and is coupled to rotate with and move axially along the output shaft 34. The coupler functions in substantially the same manner as the coupler described above with reference to FIGS. 3-12. However, for completeness, an alternative coupler and chamber configuration is illustrated in FIGS. 13 and 14 to include an actuator piston 234 disposed within an actuating chamber 236 that is isolated from the clutch chamber 232 to facilitate controlled movement of the coupler from its engaged position to its disengaged position.

The pressure control system 240 shown in FIGS. 13 and 14 communicates with the pump chamber 222 via first and second pump conduits 242 and 244, with the coupler chamber 232 via a coupler conduit 246 and with the actuating chamber 236 via an actuator conduit 248. The pressure control system further includes a second pump 250 driven by a power source such as the illustrated electric motor 252.

In this embodiment, the first pump 220 is used in lieu of the clutch pack to provide a resistant torque. As is generally known in the art, the higher the pressure within the pump chamber, the higher the resistant torque. It should be noted that while the second pump is described as being driven by an electric motor to provide second stage torque biasing even without relative rotation or first stage torque biasing, the second pump may also be driven by other mechanisms including the drive train.

Thus, the first torque biasing mechanism is again controlled by system pressure. Just as with the first embodiment, when the system pressure reaches a designated level, the ECU 254 sends a biasing signal that changes the position of the position valve 260 from the initial position shown in FIG. 13 to the cross-over position shown in FIG. 14 thereby causing the hybrid clutch 218 to engage and the input and output shafts to rotate at the same speed. When the biasing signal is removed, the position valve 260 returns to the position shown in FIG. 13 and the second biasing mechanism (e.g., hybrid clutch 218) is moved to its disengaged condition under the return force generated by the fluid pressure in the actuating chamber 236 acting on the actuator piston 234. Based on the above description, those skilled in the art will appreciate that the second pump 250 provides fluid pressure for actuation of the second torque biasing mechanism position change and also feeds fluid to the first pump 220. Thus, one advantage of this second embodiment is that the second torque biasing mechanism can be controlled to engage even if there is no relative rotation between the input and output shafts. This embodiment and the additional advantages further illustrate the design variability of the present invention.

While those skilled in the art will appreciate that the sizes of the respective pumps may vary based upon the design requirements, it is contemplated that the first pump 220 will generally be a higher pressure pump than the second pump 250 so as to minimize the size and weight of the second pump. It is further noted that the first pump provides flow stability at lower speeds and is capable of providing the resistant torque for the application.

Those skilled in the art will appreciate from the above description that the hydraulically controlled two step torque biasing assembly of the present invention may, with reference to the embodiment shown in FIG. 3, use an external pump, such as the second pump 250 shown in FIGS. 13 and 14, instead of the pump 70 shown in FIG. 3. In this arrangement, the external pump may be driven by a power source, such as an electric motor, to selectively generate pressurized fluid to the pressure control system in response to sensed rotation of the first or second shafts. The pressure control system may again be used to distribute fluid to the first torque biasing mechanism, e.g., the hydraulically actuated friction clutch 60 shown in FIG. 3 or equivalent clutch mechanism, and to the second torque biasing mechanism, e.g., the hybrid clutch 62, to achieve two step torque biasing.

The present invention is further directed to a method of using a torque biasing assembly, such as that described above, to provide two step torque biasing to control the relative rotation between the rotatable casing and first driven shaft. As noted above, the torque biasing assembly includes the first and second torque biasing mechanisms, each operable in an engaged condition to impede rotation of the first driven shaft relative to the casing and a second disengaged condition. The pump of the first torque biasing mechanism includes a first element rotating with the rotatable casing and a second element rotating with the first driven shaft. The pressure control system communicates with the first and second torque biasing mechanisms, including the pump. In view of the operation of the torque biasing assembly discussed in detail herein, those skilled in the art will appreciate that the steps of the method may include (a) operating the pressure control system to allow fluid to flow freely through the pump to place said torque biasing assembly in a no biasing state; (b) operating the pressure control system to restrict fluid flow from the pump to generate pressurized fluid and to place the first torque biasing mechanism in its engaged condition and the torque biasing assembly in its first biasing state; and (c) operating the pressure control system to communicate pressurized fluid from the pump to said second torque biasing mechanism to place said torque biasing assembly in a second biasing state. Those skilled in the art will further appreciate from the embodiments and operation of the invention described herein that other steps relating to controlling the state of the torque biasing assembly and the pressure control system provide further steps for controlling the relative rotation between the rotatable casing and first driven shaft.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1 A vehicle comprising:
a rotational input;
a first driven shaft;
a torque biasing assembly having a casing, said first driven shaft being rotatable relative to said casing, said torque biasing assembly including
a first torque biasing mechanism operatively connected to said casing and said first driven shaft, said first torque biasing mechanism being operable in an engaged condition to impede rotation of said first driven shaft relative to said casing and a disengaged condition;
a second torque biasing mechanism operatively connected to said casing and said first driven shaft, said second torque biasing mechanism being operable in an engaged condition to impede rotation of said first driven shaft relative to said casing and a disengaged condition; and
a pressure control system communicating with said first and second torque biasing mechanisms, said pressure control system configured to selectively communicate pressurized fluid to said first and second torque biasing mechanism to position said torque biasing assembly in
a no biasing state wherein said first and second torque biasing mechanisms are in said disengaged conditions,
a first biasing state wherein said first biasing mechanism is in said engaged condition and said second biasing mechanism is in said disengaged condition, and
a second biasing state wherein said first and second biasing mechanisms are in said engaged conditions.

2. The vehicle of claim 1 further including a second driven shaft rotatable relative to said first driven shaft.

3. The vehicle of claim 2 wherein said first and second driven shafts are disposed within and rotatable relative to said casing.

4. The vehicle of claim 1 wherein said first torque biasing mechanism includes a pump having a pump chamber, a first pump element disposed within said pump chamber and rotating with said first shaft, and a second element disposed within said pump chamber and fixed to said casing whereby said first and second pump elements displace fluid in said chamber when said first shaft rotates relative to said casing.

5. The vehicle of claim 4 wherein said pressure control system includes pump inlet and outlet conduits communicating with said pump chamber, a reservoir conduit communicating with a fluid reservoir, and wherein said pressure control system is operable in a non-biasing mode wherein said pump outlet conduit communicates with said fluid reservoir, said first biasing mechanism being in said disengaged condition when said pressure control system operates in said non-biasing mode, wherein said pressure control system is further operable in a first biasing mode wherein said pump outlet conduit is hydraulically isolated from said fluid reservoir, said first biasing mechanism being in said engaged condition when said pressure control system operates in said first biasing mode, wherein said pressure control system is further operable in a second biasing mode wherein said pump outlet conduit is hydraulically isolated from said fluid reservoir and said pump outlet is hydraulically connected to said second biasing mechanism.

6. The vehicle of claim 5 wherein said first torque biasing mechanism further includes a friction clutch and a clutch actuator and wherein said pressure control system communicates pressurized fluid generated by said pump to said clutch actuator when said pressure control system operates in said first biasing mode.

7. The vehicle of claim 6 wherein said pressure control system further includes an actuator conduit and a position valve in said actuator conduit, said position valve being movable between a first position and a second position, said actuator conduit hydraulically communicating with said clutch actuator when said position valve is in said first position, said actuator conduit hydraulically communicating with said clutch actuator and said second torque biasing mechanism when said position control valve is in said second position.

8. The vehicle of claim 1 wherein said casing includes a clutch chamber and said second torque biasing mechanism includes a coupler disposed in said clutch chamber, fixed to rotate with said first driven shaft, and axially movable along said first shaft between a disengaged position and an engaged position, said coupler and first driven shaft being rotatably coupled to said casing when said coupler is in said engaged position, said coupler being biased into said disengaged position.

9. The vehicle of claim 8 wherein said coupler includes a flange, a body extending axially from said flange, and a piston tooth extending radially from said body, wherein said case includes a tooth extending radially into said chamber, said piston tooth engaging said case tooth to rotationally couple said coupler to said casing when said coupler is in said engaged position.

10. The vehicle of claim 9 wherein said casing defines an annular cavity extending axially along said chamber, said coupler being axially movable along said first drive shaft when said coupler tooth is disposed in said annular cavity.

11. The vehicle of claim 10 wherein said coupler flange separates said case chamber into a first sub-chamber and a second sub-chamber, wherein said pressure control system further includes a first conduit communicating with said first sub-chamber for selectively providing pressurized fluid to said first sub-chamber when said pressure control system is in said second biasing mode, and wherein said coupler includes a fluid passage having first and second axial legs and a radial leg, said first axial leg communicating with said first sub-chamber, said second axial leg and said radial leg communicating with said second sub-chamber.

12. The vehicle of claim 11 wherein said fluid passage is in said coupler tooth.

13. A torque biasing assembly for selectively resisting relative rotation between a casing and a first driven shaft disposed in said casing, said torque biasing assembly comprising:
a casing having a chamber;
a first driven shaft disposed within and rotatable relative to said casing;
a first torque biasing mechanism operable in an engaged condition to impede rotation of said first driven shaft relative to said casing and a disengaged condition;
a second torque biasing mechanism operable in an engaged condition to impede rotation of said first driven shaft relative to said casing and a disengaged condition, said second torque biasing mechanism including a coupler disposed in said chamber, fixed to rotate with said first driven shaft, and axially movable along said first shaft between a disengaged position and an engaged position, said coupler and first driven shaft being rotatably coupled to said casing when said coupler is in said engaged position, said coupler being biased into said disengaged position; and
a pressure control system communicating with said first and second torque biasing mechanisms, said pressure control system configured to selectively communicate pressurized fluid to said first and second torque biasing mechanism to position said torque biasing assembly in
a no biasing state wherein said first and second torque biasing mechanisms are in said disengaged conditions,
a first biasing state wherein said first biasing mechanism is in said engaged condition and said second biasing mechanism is in said disengaged state, and
a second biasing state wherein said first and second biasing mechanisms are in said engaged conditions.

14. The torque biasing assembly of claim 13 wherein said coupler includes a flange, a body extending axially from said flange, and a piston tooth extending radially from said body, wherein said case includes a tooth extending radially into said chamber, said piston tooth engaging said case tooth to rotationally couple said coupler to said casing when said coupler is in said engaged position.

15. The torque biasing assembly of claim 14 wherein said casing defines an annular cavity extending axially along said chamber, said coupler being axially movable along said first drive shaft when said coupler tooth is disposed in said annular cavity.

16. The torque biasing assembly of claim 15 wherein said coupler flange separates said case chamber into a first sub-chamber and a second sub-chamber, wherein said pressure control system further includes a first conduit communicating with said first sub-chamber for selectively providing pressurized fluid to said first sub-chamber when said pressure control system is in said second biasing mode, and wherein said coupler includes a fluid passage having first and second axial legs and a radial leg, said first axial leg communicating with said first sub-chamber, said second axial leg and said radial leg communicating with said second sub-chamber.

17. The torque biasing assembly of claim 16 wherein said fluid passage is in said coupler tooth.

18. The torque biasing assembly of claim 13 wherein said pressure control system includes a control valve assembly, a pump inlet and outlet communicating with said pump chamber and said control valve assembly, a reservoir conduit communicating with said reservoir and said control valve assembly, a position valve communicating with said control valve assembly and said second torque biasing mechanism, and an electronic control module communicating with said control valve assembly and said position valve to selectively operate said pressure control system in its no biasing state, first biasing state, or second biasing state.

19. The torque biasing assembly of claim 18 wherein said control valve assembly includes first, second, third, and fourth conduit segments each having a check valve to permit fluid flow in a single direction and a bypass conduit having a control valve movable between an open position and a closed position, said control valve being in said closed position when said pressure control system is in said first or second biasing state and said open position when said pressure control system is in said no biasing state.

20. A method of using a torque biasing assembly to control relative rotation between a casing and a first driven shaft, the torque biasing assembly includes first and second torque biasing mechanisms each operable in an engaged condition to impede rotation of the first driven shaft relative to the casing and a second disengaged condition, the first torque biasing mechanism includes a pump having a first element rotating with the rotatable casing and a second element rotating with the first driven shaft, the torque biasing assembly further includes a pressure control system communicating with the first and second torque biasing mechanisms, wherein said method includes the steps of:
selectively placing the torque biasing assembly in a no-biasing state, a first biasing state, and a second biasing state by controlling fluid flow through the pressure control system, including selectively
a) operating the pressure control system to allow fluid to flow freely through the pump to place the torque biasing assembly in a no biasing state;
b) operating the pressure control system to restrict fluid flow from the pump to generate pressurized fluid and to place the first torque biasing mechanism in its engaged condition and the torque biasing assembly in its first biasing state; and
c) operating the pressure control system to communicate pressurized fluid from the pump to said second torque biasing mechanism to place said torque biasing assembly in a second biasing state.
